(19) United States
(12) Patent Application Publication
(10) Pub. No.: US 2007/0132254 A1
(43) Pub. Date: Jun. 14, 2007

(54) Apparatus for gripping articles

(75) Inventor: Kyoung-Soo Choi, Kyunggi-do (KR)

Correspondence Address: LAW OFFICE OF DELIO & PETERSON, LLC., 121 WHITNEY AVENUE, 3RD FLLOR, NEW HAVEN, CT, 06510, US

(73) Assignee: Komelon Corporation

(21) Appl. No.: 11/433,089

(22) Filed: May 12, 2006

(30) Foreign Application Priority Data
Dec. 8, 2005 (KR) 0119476/2005

(51) Int. Cl. B65G 7/12

(52) U.S. Cl. 294/15; 294/27.1

(57) ABSTRACT

The apparatus includes a first plate for supporting the first surface of the article adjacent to the edge part of the article, a second plate extending from one end of the first plate in order to support the second surface of the article adjacent to the edge part of the article, a band connected to both side ends of the first plate such that a worker is able to securely hold the apparatus using one hand, and a non-skid member attached to at least one of inner surfaces of the first and second plates, which make contact with the first and second surfaces of the article, so as to prevent the apparatus from sliding along the article.

### BACKGROUND OF THE INVENTION

1. Field of the Invention

The present invention relates to an apparatus for gripping an article. More particularly, the present invention relates to an apparatus for gripping an article, which allows a worker to easily and safely transfer the article while gripping an edge part of the article using the apparatus.

2. Description of the Prior Art

As generally known in the art, a worker may feel inconvenienced when the worker grips edge parts of an article, such as furniture, a glass plate, a metal plate or a construction material, in order to transfer the article to another place.

That is, when the worker directly grips the edge parts of the article using hands, the worker must support the article using fingers while gripping the edge parts of the article using the palm of the hand such that the article can be prevented from being separated from the hands of the worker. Thus, the edge parts of the article may exert pressure upon the palm of the hand or fingers making contact with the edge parts of the article, so that the worker may feel pain.

In addition, since the worker must apply strong force to the article in order to securely grip the article, not only muscular pain may occur in the arms and shoulders of the worker, but also the worker may easily feel fatigued. If the worker feels pain in the hands or the arms, the worker must take rest while stopping article transfer work, so the article transfer work may be delayed. In particular, if the article has sharp or rough edge parts, hands of the worker may be frequently damaged due to the sharp or rough edge parts.

### SUMMARY OF THE INVENTION

Accordingly, the present invention has been made to solve the above-mentioned problems occurring in the prior art, and an object of the present invention is to provide an apparatus for gripping an article, which allows a worker to easily and safely transfer the article by gripping an edge part of the article using the apparatus.

Another object of the present invention is to provide an apparatus for gripping an article, which allows a worker to safely grip the article with a little force while effectively preventing hands of the worker from being damaged or injured by edge parts of the article.

Still another object of the present invention is to provide an apparatus for gripping an article, which can be simply fitted on the hand of the worker.

In order to accomplish these objects, there is provided a gripping apparatus for gripping and transferring an article having an edge part defined between a first surface and a second surface of the article, the gripping apparatus comprising: a first plate for supporting the first surface of the article adjacent to the edge part of the article; a second plate extending from one end of the first plate in order to support the second surface of the article adjacent to the edge part of the article; a band connected to both side ends of the first plate such that a worker is able to securely hold the apparatus using one hand; and a non-skid member attached to at least one of inner surfaces of the first and second plates, which make contact with the first and second surfaces of the article, so as to prevent the apparatus from sliding along the article.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating an article and an apparatus for gripping the article according to the present invention;

FIG. 2 is a frontal perspective view illustrating the structure of an apparatus for gripping an article according to the present invention;

FIG. 3 is a sectional view taken along line III-III shown in FIG. 2;

FIG. 4 is a sectional view taken along line IV-IV shown in FIG. 2;

FIG. 5 is a perspective view illustrating the structure of an apparatus for gripping an article according to another embodiment of the present invention; and

FIG. 6 is a perspective view illustrating that a worker equipped in one hand thereof with an apparatus for gripping an article according to the present invention grips the article.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

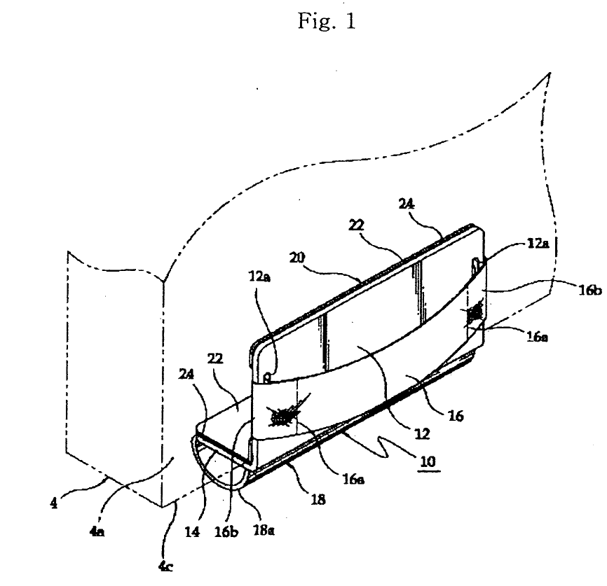

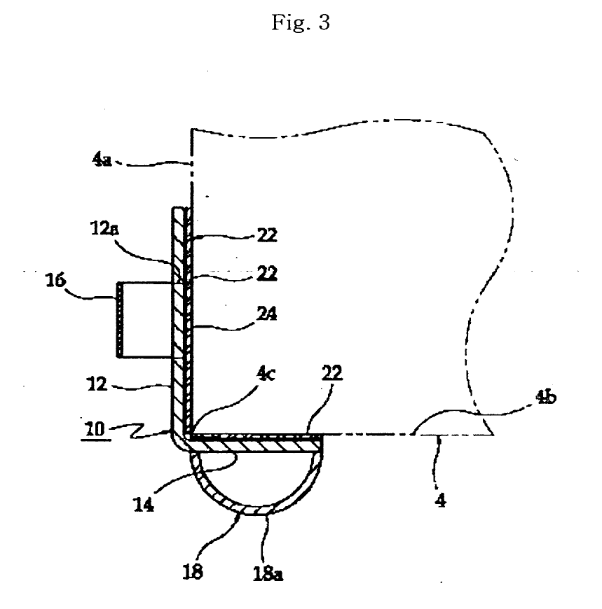

Referring to FIGS. 1, 3 and 6, a worker can grip an article 4 having an edge part 4c defined between a first surface 4a and a second surface 4b of the article 4 in a state in which an apparatus 10 for gripping an article according to the present invention is fitted on the hand of the worker.

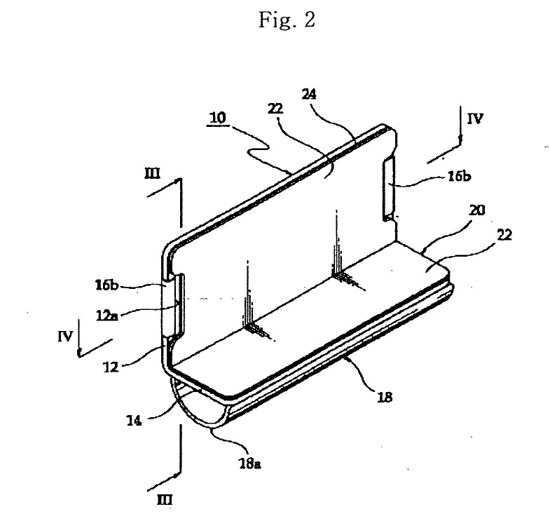

Referring to FIGS. 1 to 4 and 6, the apparatus 10 for gripping an article according to the present invention includes a first plate 12 for supporting the first surface 4a of the article 4 adjacent to the edge part 4c of the article 4 and a second plate 14 extending from one end of the first plate 12 in order to support the second surface 4b of the article 4 adjacent to the edge part 4c of the article 4.

It is sufficient for the first plate 12 to have a size corresponding to the palm of the worker's hand. In addition, it is sufficient for the second plate 14 to have a size corresponding to ½ to ⅗ of the size of the first plate 21. If the first and second plates 12 and 14 have the above sizes, the palm of the worker's hand 2 and fingers 2a of the worker may not directly make contact with the article 4 in a state in which the apparatus 10 for gripping the article is fitted on the hand 2 of the worker.

The first and second plates 12 and 14 of the gripping apparatus 10 are made from a synthetic resin plate, such as an acrylic resin plate or a polyvinyl chloride (PVC) plate. The first plate 12 can be integrally formed with the second plate 14 by bending the synthetic resin plate in an L-shaped structure. In addition, it is also possible to integrally form the first plate 12 with the second plate 14 by bending a metal plate in an L-shaped structure. Edge parts of the first and second plates 12 and 14 are smoothly treated through precision processing so as to prevent hands of the worker from being damaged by the edge parts of the first and second plates 12 and 14. Although FIGS. 1 to 3 illustrate the first and second plates 12 and 14, which are bent at a right angle, this is illustrative purposes only. A bending angle between the first and second plates 12 and 14 can be variously adjusted depending on applications.

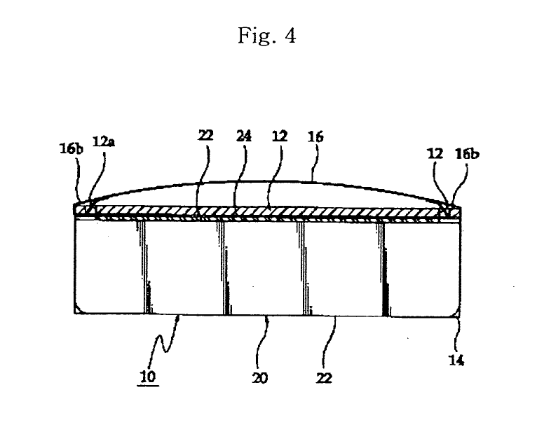

Meanwhile, the apparatus 10 for gripping the article according to the present invention includes a band 16 coupled with both side ends of the first plate 12 so as to allow the apparatus 10 to be fitted on the hand 2 of the worker. Preferably, the band 16 includes an elastic band. A pair of slots 12a are formed at both side ends of the first plate 12. As shown in FIGS. 1 and 4, both ends of the band 16 are inserted into the slots 12a formed in the first plate 12 and then sewed to a body of the band 16 along sewing lines 16a, thereby forming loops 16b at both sides of the band 16 in such a manner that the band 16 can be prevented from being separated from the slots 12a. If the worker puts the hand 2 between the first plate 12 and the band 16 such that the palm of the hand 2 faces the first plate 12 and the back of the hand 2 faces the band 16, the band 16 is elastically biased toward the hand 2 of the worker so that the worker can securely hold the apparatus 10 for gripping the article.

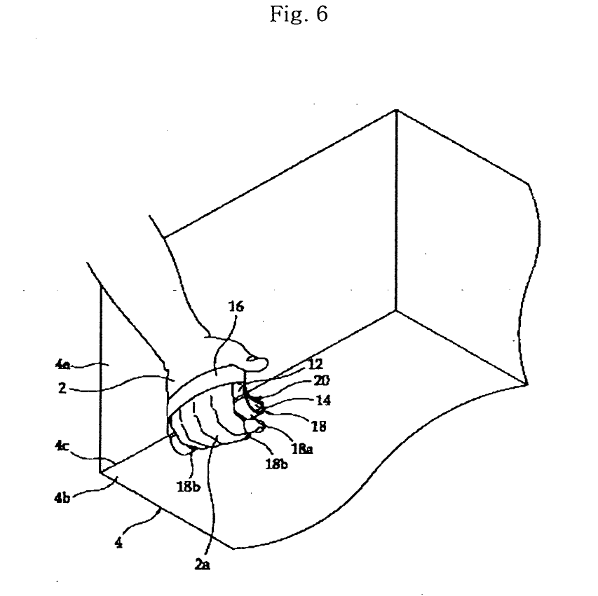

The apparatus 10 for gripping the article according to the present invention includes a grip bar 18 coupled to an outer surface of the second plate 14 such that the worker can grip the grip bar 18 using fingers 2a. A front upper portion of the grip bar 18 is attached to the second plate 14 in line with a lateral side end of the second plate 14 and a rear upper portion of the grip bar 18 is attached to the second plate 14 adjacent to the edge part of the apparatus 10 defined between the first and second plates 12 and 14. The grip bar 18 can be fixed to the outer surface of the second plate 14 by means of adhesives. As shown in FIG. 6, an outer surface 18a of the grip bar 18 has a semi-circular shape so that the worker can easily grip the grip bar 18 by surrounding the outer surface 18a of the grip bar 18 using fingers 2a.

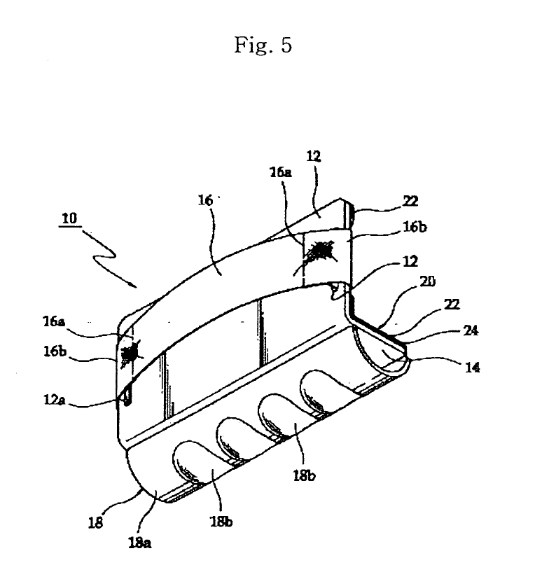

FIG. 5 shows an apparatus 10 for gripping an article according to another embodiment of the present invention. Referring to FIG. 5, a plurality of grooves 18b are formed on the outer surface 18a of the grip bar 18 in order to receive fingers 2a of the worker in such a manner that the fingers 2a of the worker can be prevented from sliding along the outer surface 18a of the grip bar 18.

Referring to FIGS. 1 to 6, non-skid members 20, such as rubber plates 22, are bonded to inner surfaces of the first and second plates 12 and 14, which make contact with the first and second surfaces 4a and 4b of the article 4, by means of an adhesive 24. The rubber plates 22 have a higher frictional coefficient and superior flexibility so that the worker can stably grip the article 4 when the rubber plates 22 adhere to the first and second surfaces 4a and 4b of the article 4 because the rubber plates 22 can prevent the apparatus 10 from sliding with respect to the article 4. In addition to the rubber plate 22, a polyurethane plate or a silicon rubber plate having superior flexibility can be used as the non-skid member 20. Although it has been described and illustrated that the rubber plates 22 are attached to both inner surfaces of the first and second plates 12 and 14, respectively, it is also possible to selectively attach the rubber plate 22 to one of the first and second plates 12 and 14.

Hereinafter, the operation of the gripping apparatus having the above structure according to the present invention will be described.

As shown in FIGS. 1, 3 and 6, if the worker puts the hand 2 between the first plate 12 and the band 16 such that the palm of the hand 2 faces the first plate 12 and the back of the hand 2 faces the band 16, the band 16 is elastically biased toward the hand 2 of the worker so that the worker can securely hold the apparatus 10 for gripping the article. At this time, the apparatus 10 for gripping the article can be fitted on one hand or both hands of the worker depending on the size and shape of the article 4.

Then, the worker supports the first surface 4a (that is, the side surface) of the article 4 adjacent to the edge part 4c of the article 4 by using the first plate 12 of the gripping apparatus 10, and supports the second surface 4b (that is, the lower surface) of the article 4 adjacent to the edge part 4c of the article by using the second plate 14 of the gripping device 10.

In this state, if the worker applies force to the grip bar 18 by using fingers 2a such that the first and second plates 12 and 14 closely adhere to the first and second surfaces 4a and 4b of the article 4, the worker can simply and stably grip and lift the article. In addition, as shown in FIG. 5, if the fingers 2a of the worker are rested on the grooves 18b formed on the outer surface 18a of the grip bar 18, the fingers 2a of the worker can be prevented from sliding along the outer surface 18a of the grip bar 18. In addition, since the rubber plates 22 have a higher frictional coefficient and superior flexibility, the article 4 can be prevented from sliding from the gripping apparatus 10 by means of the rubber plates 22, so that the worker can securely grip the article 4.

In addition, the worker can grip the article 4 without causing the palm of the worker's hand and fingers 2a of the worker to make contact with the edge part 4c of the article 4, so that the worker can be prevented from being hurt or injured by the edge part 4c of the article 4. In particular, the worker can easily and safely transfer the article 4 even if the article 4 has sharp edge parts or rough edge parts.

Meanwhile, the worker equipped with the gripping apparatus 10 can simply release the gripping apparatus 10 from the hand of the worker if the worker extends the fingers 2a of one hand equipped with the gripping apparatus 10 and then withdraws the hand from the band 16 while holding the gripping apparatus 10 using the other hand.

As described above, the apparatus for gripping the article according to the present invention may allow the worker to easily and safely transfer the article by gripping the edge part of the article using the gripping apparatus. In addition, the apparatus for gripping the article according to the present invention may allow the worker to safely grip the article with a little force while effectively preventing hands of the worker from being damaged or injured by edge parts of the article. Furthermore, the apparatus for gripping the article according to the present invention can be simply fitted on the hand of the worker.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A gripping apparatus for gripping and transferring an article having an edge part defined between a first surface and a second surface of the article, the gripping apparatus comprising:
a first plate for supporting the first surface of the article adjacent to the edge part of the article;
a second plate extending from one end of the first plate in order to support the second surface of the article adjacent to the edge part of the article;
a band connected to both side ends of the first plate such that a worker is able to securely hold the apparatus using one hand; and
a non-skid member attached to at least one of inner surfaces of the first and second plates, which make contact with the first and second surfaces of the article, so as to prevent the apparatus from sliding along the article.

2. The gripping apparatus as claimed in claim 1, further comprising a grip bar coupled to an outer surface of the second plate in such a manner that the worker grips the grip bar with a predetermined force using fingers.

3. The gripping apparatus as claimed in claim 2, wherein an outer surface of the grip bar is curved such that the worker easily grips the grip bar with a predetermined force using fingers.

4. The gripping apparatus as claimed in claim 2 or 3, wherein a plurality of grooves are formed on the outer surface of the grip bar so as to receive fingers of the worker such that the fingers of the worker are prevented from sliding along the grip bar.

5. The gripping apparatus as claimed in claim 2 or 3, wherein the band has elasticity and the non-skid member includes a rubber plate.
